(19) United States
(12) Patent Application Publication
(10) Pub. No.: US 2019/0177578 A1
(43) Pub. Date: Jun. 13, 2019

(54) Cushioned Graphics Mounting Board

(71) Applicant: The Gilman Brothers Company, Gilman, CT (US)

(72) Inventors: Donald R. Dressler, Glastonbury, CT (US); Evan Gilman, Gilman, CT (US)

(21) Appl. No.: 16/218,951

(22) Filed: Dec. 13, 2018

Related U.S. Application Data
(60) Provisional application No. 62/598,171, filed on Dec. 13, 2017.

(51) Int. Cl. C09J 7/40; C09J 7/38

(52) U.S. Cl. CPC C09J 7/403; C09J 7/38; C09J 7/405

(57) ABSTRACT

A pressure activated graphics mounting system and associated adhesive system that reduces mottle and texture from the mounting of decorations to rigid substrates, comprising (a) a relatively rigid substrate having a base surface on which a graphic is to be applied; (b) an optional, relatively softer cushion layer adhered to the base surface of the substrate; (c) a pressure sensitive adhesive layer preferably at least 0.0030 inch thick having a lower surface adhered to the cushion layer and an active upper surface for securely mounting the graphic; and (d) a multiplicity of discrete barrier structures distributed on the adhesive layer and projecting at least 0.0015 inch from the active surface of the adhesive layer.

### BACKGROUND

The present invention relates to graphics mounting systems that facilitate sliding or repositioning of the graphic on an adhesive surface of a mounting substrate, before the graphic is permanently adhered to the substrate.

U.S. Pat. Nos. 6,083,616 and 6,630,049 disclose graphics mounting systems and techniques for this purpose. These disclosures are incorporated by reference as examples of known systems and techniques in which the present invention can be incorporated.

The '616 patent discloses a rigid substrate for the mounting of photographic prints and the like, which has a non-tack pressure sensitive or activated adhesive on one side for the attachment of a print for display. A differential height barrier structure deposited on the adhesive surface temporarily neutralizes the adhesive tack to allow the print to slide on the surface of the adhesive for easy positioning and subsequent mounting to the board with minimal pressure. Air bubbles during mounting are substantially eliminated by equally spaced non-adhesive barrier structures on top of the tacky adhesive layer. This creates exhaust channels for air flow during application of mounting pressure that activates the adhesive.

It should be understood that mounting boards include either a pressure sensitive adhesive (PSA) or a heat activated adhesive (HAA) to bond to a graphics item. PSA coated boards are most reliable when high tack permanent adhesives are used. Permanent PSA is so tacky that it is very difficult to align the photograph or print to the adhesive coated board prior to joining the two either with a laminator or by hand roller.

A bubble free and dirt-free lamination is very difficult to achieve for even the best professional in the best workspace with the best equipment. A novice is very likely to fail on a defect free mounting attempt. Static charges in the air contribute to small particles jumping onto the adhesive surface and appearing when viewing the final mounted photograph or poster. Most of these particles are so small they cannot be seen by the eye or cleaned off a tacky adhesive surface. Once an air pocket is trapped between the adhesive layer and the photograph or poster it cannot be worked out or moved.

A major disadvantage of PSA coated mounting boards is the accentuation of the substrate rigid board texture and the mounting PSA coating texture to visibly appear on the photograph or print after it is mounted. With the present industry standard mounting boards with PSA coating, any photograph or poster will always look worst once it is mounted compared to the unmounted original. This has been a compromise the industry and consumers have reluctantly had to accept.

Another disadvantage associated with the mounting of photographs and posters arises when using laminating equipment (driven nip rollers) to bond the graphics item to the tacky adhesive coated board. It is very difficult to laminate a flat board with PSA and a photograph or poster through a laminator and not add some additional bow to the final mounted item. In part this bow is caused by the inability to lay the mounted item in a flat position on the adhesive prior to sending it through the nip rolls of a laminator. Due to the tackiness of the PSA, one has to hold the photograph or poster off the adhesive and usually tight against the profile of the top laminating roll to avoid wrinkles and air. This technique puts a tension compression stress in the lamination and causes the rigid board to bow as it comes out of the laminator.

### SUMMARY OF THE INVENTION

According to an aspect of the present invention, an improved appearance, such as reduction of mottle and texture from the mounting of graphics to rigid substrates, is accomplished by the addition of a cushion layer underneath the barrier-embedded mounting adhesive, preferably in the form of a soft, smooth, cellular foam layer.

According to another aspect a similar benefit is achieved without the cushion layer, by increasing the size of the barrier structure and thickness of the mounting adhesive.

The most noteworthy context for practicing the invention and the basis for the present disclosure is the mounting of a graphics item or product onto a substrate, but the aspects of the invention are more broadly applicable to the mounting of any decoration on a substrate.

The difficulties and issues with mounting graphics to high tack PSA boards have been overcome with novel adhesive systems and adhesive lined mounting boards, which achieve permanent and reliable bonding of photographs and posters to a rigid board with a high tack PSA that is initially non-tacky.

An embodiment in the form of a pressure activated graphics mounting system comprises a relatively hard substrate having a base surface on which a graphic is to be applied; a relatively softer cushion layer adhered to the base surface of the substrate; a pressure sensitive adhesive layer having an inner surface adhered to the cushion layer and an active outer surface for securely mounting the graphic; and a multiplicity of discrete barrier structures distributed in the adhesive layer and projecting from the outer surface. The substrate is preferably a foam board, and in the fully mounted condition a graphics product is bonded to the adhesive layer with the barrier structure producing localized deformation in the adhesive layer and underlying cushion layer.

Whether or not incorporated into a graphics mounting system, the preferred adhesive system comprises an adhesive layer having a front surface for receiving the decoration and a back surface; a multiplicity of discrete barrier structures distributed on the adhesive layer and projecting from the front surface; and a cushion layer adhered to the back surface of the adhesive layer.

The invention is applicable to the mounting of photographs, posters, and the like to a rigid substrate or board in the picture framing, sign, display, and retail consumer markets. These mounting boards may be flat sheets of metal such as aluminum, plastic sheets made out of solid acrylic sheet, foamed PVC (such as the Sintra brand), polystyrene, aluminum composites (such as the Dibond brand), and cellulosic such as paper or wood, and plastic foam boards, etc.

Foamboards are very popular because they are the least expensive and lightest in weight of the rigid board products. Foam boards are also the easiest to cut and trim and in many cases are the only boards that can be cut by a novice with common hand razor knives. Inclusion of a cellular foam layer under the adhesive on a foamboard allows for reliable, defect free mounting of photography and posters of any size by a novice with a small hobby store six inch hand roller.

The mounting system can also be used for other forms of decoration and substrates, such as tiles on building surfaces.

Whether or not a cushion layer is present, the improved transfer liner for embedding the barrier structure in the adhesive layer comprises a base film, a carrier layer having a lower surface bonded to the base film and an upper surface covered with a release material, and a multiplicity of discrete hard barrier structures uniformly distributed within the carrier layer. The barrier height is considered transverse to the upper surface of the carrier layer, and the barriers are embedded in the carrier layer flush with release material. The size (height or effective length) of the barrier structure is preferably dependent on whether the cushion layer is present, with the objective in either case of transferring the barrier structure such that when distributed on or embedded in the adhesive layer, the barrier structure projects at least about 0.0010 inch (preferably 0.0015-0.0025 inch but up to 0.0050 inch) from the active surface of the adhesive.

If no cushion layer is present, the adhesive layer should have a thickness that is at least about twice the height of the barrier structure, e.g., at least about 0.0040 inch adhesive thickness for a barrier structure having a height of 0.002 inch. The thicker adhesive layer simulates to some extent the presence of a cushion layer in facilitating the full absorption of the barrier structure and other irregularities during application of the final mounting pressure.

Increasing the adhesive layer thickness adds a significant cost of manufacturing, whereas providing the relatively low-cost cushion layer cost-effectively achieves superior performance, especially for the mounting of graphics. When combined with a cushion layer, the barrier structure has an ideal height of about 0.0020 inch for transfer to an adhesive layer that is at least 0.0030 inch thick.

The invention can take various forms such as a transfer liner; a multilayer sheet or tape with adhesive; a multilayer sheet or tape without adhesive, and non-tack adhesive system that becomes become highly tacky when mounting pressure is applied through a decoration.

### BRIEF DESCRIPTION OF THE DRAWINGS

Non-limiting embodiments of the invention are described in greater detail below, with reference to the accompanying drawing, in which:

FIG. 1 depicts a foamboard incorporating an embodiment of the present invention, ready for the mounting of a graphics product such as a photograph;

FIG. 2 depicts the foamboard of FIG. 1, with a mounted graphics product;

FIG. 3 depicts a release liner for converting a conventional foam board into the improved foam board depicted in FIG. 1;

FIGS. 4A-4D depict an embodiment of the present adhesive system as provided to an end user for the mounting of a decorative product such a tile, on a substrate such as the floor of a building that does not include an adhesive surface, and the sequence of steps for completing the mounting;

FIGS. 5A-5D depict another embodiment of the adhesive system as provided to an end user for the mounting of a decorative product on a substrate that includes an adhesive surface and the sequence of steps for completing the mounting;

FIG. 6 depicts a tape or roll embodiment with adhesive;

FIG. 7 depicts an alternative tape or roll embodiment; and

FIG. 8 depicts the base layer of the release liner, with a printed grid pattern.

### DETAILED DESCRIPTION

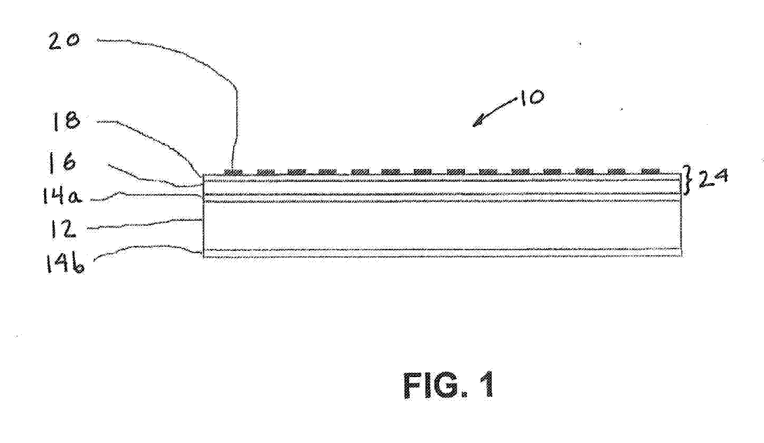

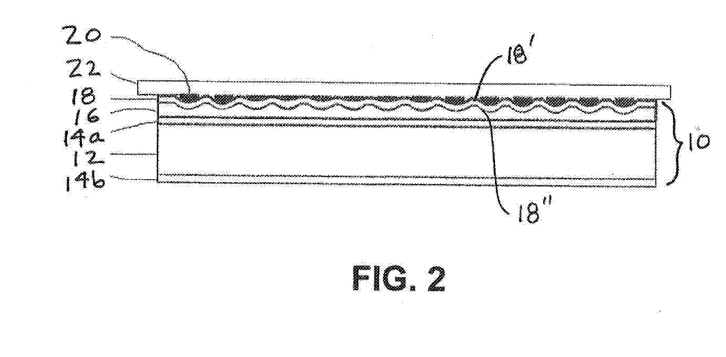

FIGS. 1 and 2 depict an embodiment 10 of the present invention on a conventional foam board. Conventional foam boards typically have a rigid foam core 12 with adhesively bonded and plastic or paper upper and lower layers 14a, 14b. As incorporated in the form of a mounting board 10, the present invention comprises a cushion layer 16 adhered to the foamboard paper or plastic upper surface 14a, a pressure sensitive adhesive layer 18 adhered to the cushion layer 16, and discrete barrier structures 20 projecting from the adhesive layer. Consequently, a highly aggressive tacky adhesive system can be temporarily neutralized by the barrier structures 20 to allow sliding and positioning of the graphics product on the adhesive surface in a lay-flat position. The present invention may be implemented by forming an array of hard, discrete structures 20 distributed substantially uniformly over 5-25%, possibly up to about 30%, of the adhesive upper (active) surface 18′. Whether or not aligned perpendicularly, the structures 20 have a preferred effective length transverse to the adhesive active surface, of at least 0.0025 inch.

When referred to as “dots”, the barrier structure is in a substantially particulate or pixelated form, such as printed pixels, that are not necessarily round or cylindrical.

The cushion layer 16 preferably comprises cellular foam with a thickness range of about 0.030-0.125 inch and a density range of 2-10 lb. per cubic foot. As transferred from a release liner, the barrier structures 20 preferably simply adhere to the top of the outer surface 18′ of the adhesive layer but can penetrate (partially embed) into the adhesive layer 18. If partially embedded, the height of the barrier structure can be greater than the projection distance from the outer surface 18′ of the adhesive layer, e.g., a barrier structure height of 0.0025 inch could be partially embedded by 0.0005 inches so the projection is 0.0020 inch. The barrier is preferably formed by an array of discrete, dot-like structures on the adhesive surface. The present invention relies on the graphic 22 to be mounted avoiding contact with any of the PSA 18 until pressure is applied either manually or by a roll laminator or mechanical/vacuum press.

As depicted in FIG. 2, when mounting pressure is applied, the discrete barrier structures 20 sink into and locally deform the upper surface 18′ of the adhesive layer 18 with a commensurate deformation of the lower surface 18″ of the adhesive layer and the cushion layer 16. This allows the active PSA 18 to contact the graphic 22 to be mounted and achieve an instant permanent bond.

The air entrapment and bubbles are eliminated due to the escape of air around and between the raised barrier pattern 20. As a result of the presence of the soft cellular foam layer 16, particles of contamination and material textures of the mounting board and adhesives are mediated from showing on the surface of the photograph or print by the cushioning of the soft cellular foam. This dramatic improvement in process reliability and appearance is not possible with a rigid board with a standard PSA including barrier structure.

Small and low structural barriers will not be effective on typical (non-smooth) substrates with the use of permanent high tack PSA adhesive due to the textures of the board and the texture of the graphic items to be mounted (which could be rough photo or poster paper or an extrusion coated heavy paper sheet with fiber texture present). The hills or tops of the two textures create a void in some areas of the barrier structures and the items stick and fail to slide during repositioning. The conventional thought would be to use larger barriers, but this intensifies the problem of irregularities showing through to the surface of the graphic. This problem is now solved by the cushioning effect of the present invention. This physically increases the separation and physical interaction between the substrate and the graphic.

Many types of graphics to be mounted are paper-like and thus characterized as uniformly thin, flat, and smooth to the naked eye, but locally deformable transversely when internal or external texture or particulates are pressed against one of the surfaces. With the present invention, such irregularities in or on the upper surface 14a of the substrate, the adhesive layer 18 and/or the lower surface of the graphic do not affect the appearance of the mounted graphic because the cushion layer 16 deforms locally to cushion and in effect “absorb” the irregularities. In this context, the barrier structures 20 also define irregularities that are “absorbed” by the cushion layer.

An embodiment of the invention can be implemented as a graphics mounting adhesive system 24 apart from a substrate, comprising (i) a pressure sensitive adhesive layer 18 having an active upper or front surface 18′ for receiving the graphic and a back surface 18″, (ii) a multiplicity of discrete barrier structures 20 distributed on (including partially in) the adhesive layer 18 and projecting from the front surface, and (iii) a cushion layer 16 adhered to the back surface 18″ of the adhesive layer.

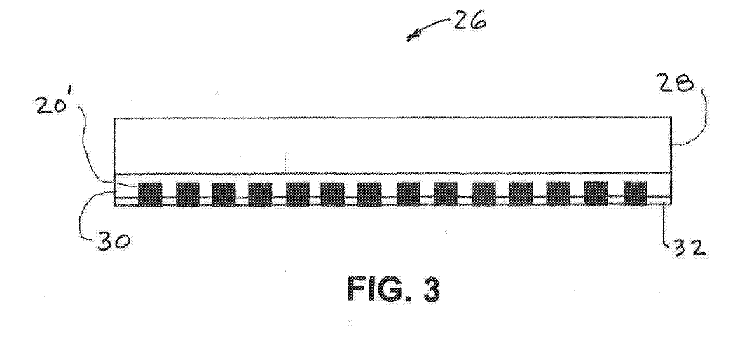

Generally, the improved foamboard embodiment would be sold to a graphics printer or the like, with a release liner 26 (FIG. 3) containing the barrier structures 20, covering the adhesive layer 18. The cushion layer 16 and adhesive layer 18 are preferably applied to the paper or plastic layer 14a of the substrate 12, 14 (FIG. 1) and then the release liner 26 is applied. However, the cushion layer 16 can be applied well before the adhesive layer 18 is applied.

The release liner 26 carries flush or projecting barrier structure 20′ that is transferred to the adhesive layer 18 when the release liner is removed immediately before of mounting the graphic, as described in U.S. Pat. No. 6,083,616. The release liner 26 would also cover the adhesive layer if the adhesive system is to be applied to the foamboard or other substrate at a later time.

The release liner includes a paper or plastic base sheet or film 28, an underlying carrier layer 30 of extruded low melt resin that tentatively holds the barrier structure 20′, and a release coating 32. When the release liner 26 is placed on the adhesive surface 18′ of the substrate, the barrier structure sticks to the adhesive layer 18. When the graphics item is to be mounted, the release liner 26 is pulled off (released from) the adhesive layer of the substrate, leaving the barriers 20′ stuck to the adhesive layer 18. The tack of the adhesive layer 18 is greater than the effective tack of the resin carrier layer 30, thereby pulling the barrier structure out of the carrier layer as the release liner is pulled off the substrate.

The adhesive system should be suitable for use by hobbyists as well as commercial framing shops, and therefor accommodate a wide degree of user focus and care during mounting of the graphic. If the barrier structure projects a relatively short distance from the adhesive surface 18′, a hobbyist could inadvertently apply excessive pressure on the graphic while positioning the graphic on the substrate, causing the graphic to locally stick to the adhesive before reaching the final position. This problem has been solved by the combination of a much longer (higher) barrier structure, preferably embedded in a much thicker adhesive layer, than was taught in U.S. Pat. No. 6,083,616. The longer barrier structure can be transferred to the adhesive in a manner analogous to that described with respect to FIG. 3 and U.S. Pat. No. 6,083,616.

Whether or not the cushion layer is present, the combination of a thicker adhesive layer (at least 0.0030 inch) and longer barrier structure (at least 0.0015 inch) permits a much higher projection of the barrier structure above the adhesive surface 18′. This minimizes the risk of sticking due excessive pressure while positioning the graphic, and also permits the use of a more aggressive adhesive.

Although a thicker adhesive layer bonded directly to the substrate can accommodate longer barriers structure that recedes fully into the adhesive layer when mounting pressure is applied, the best results are obtained when the cushion layer is present between the substrate and the adhesive layer.

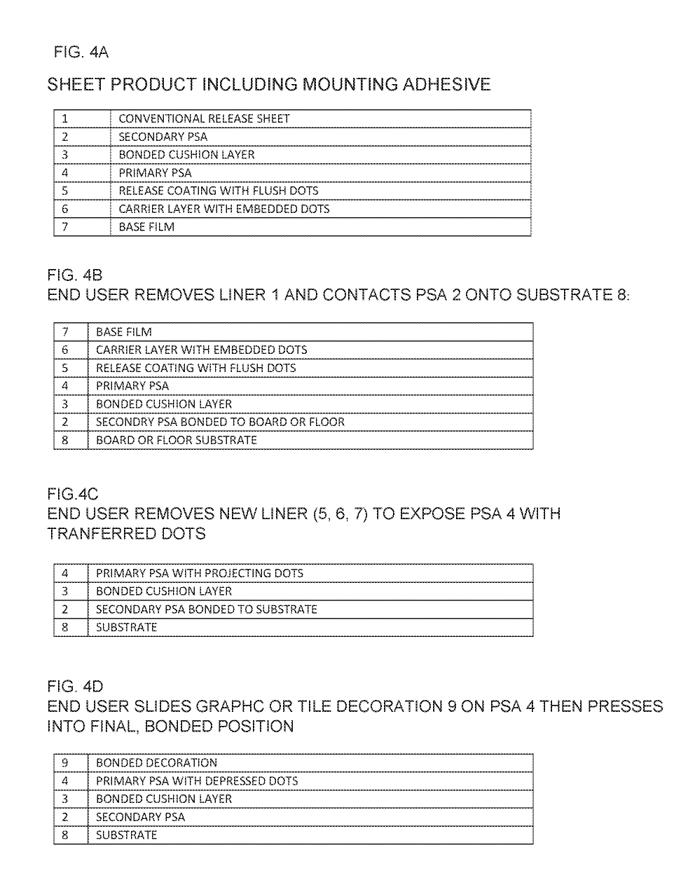

FIG. 4A depicts the layers numbered 1-7 of one embodiment of a sheet or tape release liner product that would be provided to an end user for mounting a graphic, tile, or other decoration on a substrate such as a board or building surface that does not already have a PSA layer. FIGS. 4B-D depict the end user's installation procedure. The term “primary PSA” refers to the PSA on which the decoration is attached and “secondary PSA” refers to the PSA by which the cushion layer is bonded to the substrate.

The inventive release liner (1-7) of FIG. 4A includes a primary PSA layer 4 on the side of the carrier layer 6 opposite the base layer 7, and a release sheet 1. When the end user is ready to mount the decoration 9 to the mounting substrate 8, the release sheet 1 is removed and the exposed secondary PSA 2 of the remaining release liner is placed on the substrate 8. The base layer with adhered carrier layer 6 are pulled away, thereby transferring the dots to the primary PSA layer 4. Whether or not the dots partially embed in the primary PSA, they projecting at least 0.0015 inch from the surface. The decorative piece can now be positioned with light lateral pressure to slide along the dots, until final mounting pressure or lamination is performed. In this last step 4D, the dots recede into the primary PSA 4, to the extent that all or at least most of the PSA 4 firmly bonds to the underside of the decorative piece 9.

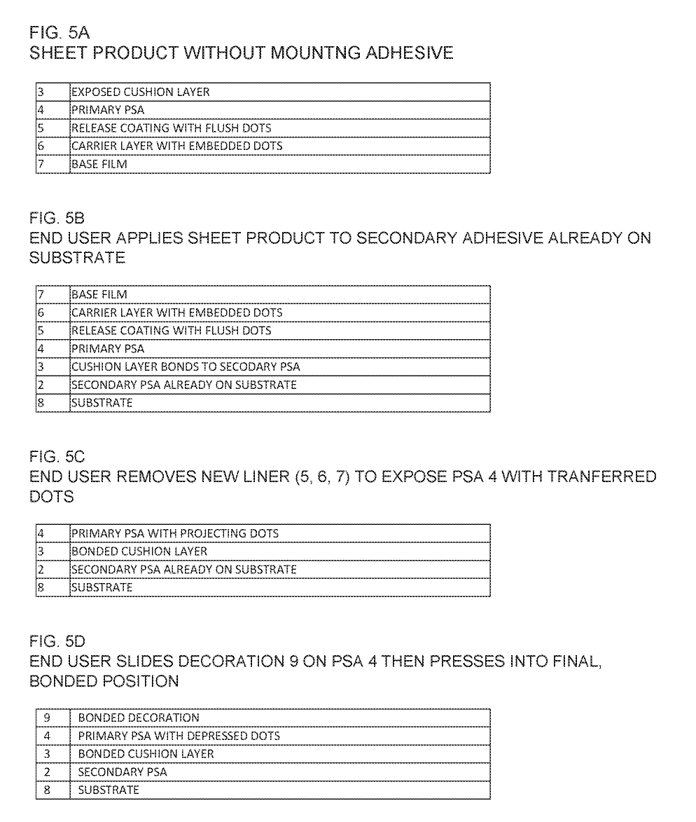

In another end-use embodiment (3-7), as depicted in FIGS. 5A-5D, the substrate 8 carries the secondary PSA adhesive 2. Typically, the secondary adhesive layer 2 is bonded to the substrate 8 and covered by its own release sheet (not shown), which is removed before the inventive release liner is positioned thereover for transfer of the dots to the primary adhesive layer 4. At that point, FIGS. 5B-5D depict the same sequence as FIGS. 4B-4D.

If no cushion layer is present, the release liner product corresponding to FIG. 4A consists of the base film 7, carrier layer 6 with embedded dots and release coating 5, primary PSA layer 4 and conventional release sheet 1. The release liner without cushion corresponding to FIG. 5A, consists of base film 7, carrier layer 6 with embedded dots, and release coating 5.

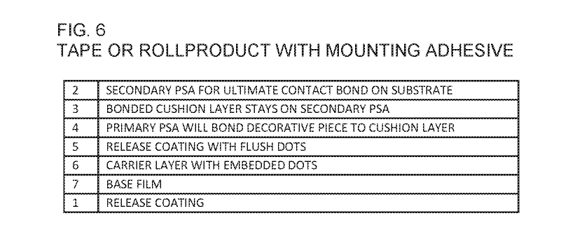

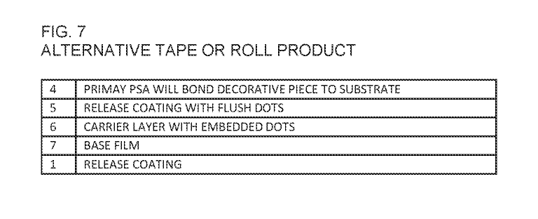

FIGS. 6 and 7 depict a configuration of layers constituting a tape or roll form of product including the primary adhesive layer for bonding the decoration. FIG. 6 shows the embodiment including the cushion layer and FIG. 7 shows the embodiment without the cushion layer. The sequence of steps when the respective products are in the hands of the end user, are self-evident from the descriptions associated with FIGS. 4 and 5.

The preferred release liner for applying an adhesive to a substrate comprises a non-adhesive base layer that is stable (non-melting) at temperatures above about 250 F, i.e., typical commercial lamination temperatures. A non-adhesive, plastic carrier layer is adhered on the bottom side of the base layer, having a melt temperature below 250 F. The dots are preferably rotary-screen printed, and then the liner is passed through a hard, smooth roll nip at a temperature of about 200 F to sink the hard dots flush into the soft EVA layer, forming one smooth film profile on the surface. A release surface covers the bottom of the carrier layer. A pattern of non-adhesive, discrete, hard plastic dots are substantially uniformly distributed throughout the carrier layer and release surface, with each dot having a preferred height in the range about 0.0015 to 0.0025 inch. The carrier layer is thicker than the length of the dots (as viewed transversely to the surface of the carrier layer). Each dot passes through the release surface into the carrier layer and is embedded in the carrier layer, flush with the release surface.

At a temperature under 200 F the hard, printed dot can easily be pushed into the EVA for achieving the desired smooth surface. Higher temperatures could result in distortion. The smooth surface is desired because if the dots project from EVA it will be difficult for the transfer liner to stay attached to the PSA adhesive surface. Projection of the dots prior to laminating to the adhesive will diminish sliding of the decorative item on the dots if some of the dots fully embed into the adhesive so the height of such dots is not available for the raised barrier effect. In other words, the portion of a dot that is not embedded flush can be fully absorbed into the PSA adhesive layer and not project from the surface of the adhesive when the release liner is removed from the adhesive.

In a preference, the base layer is a transparent paper, PET, or high-density polyethylene having a top side to bottom side thickness in the range of about 0.004-0.008 inch, with a visible printed rectilinear pattern. The carrier layer is an extruded EVA polymer, having a thickness of at least about 0.0030 inch, up to 0.125 inch thick. The dots are substantially uniformly distributed in about 5%-25% (preferably about 20%) of the release layer. The adhesive thickness is generally in the range of 0.0030-0.0050 inch. However, in some end-uses wherein the primary adhesive is foam-backed, the adhesive can be only about 0.0015-0.0030 inch thick with the dots having a lower minimum projection about 0.0010 inch.

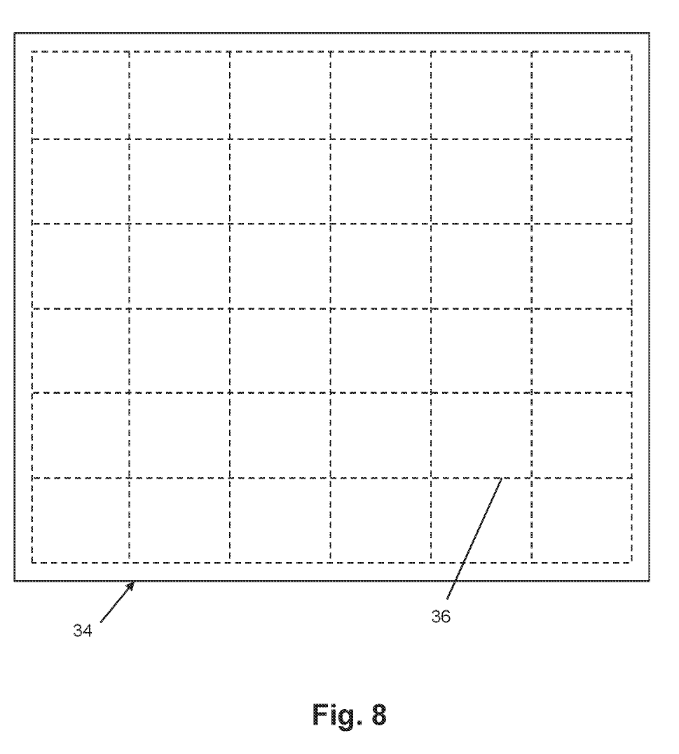

FIG. 8 depicts a representative section of rectilinear plastic film 34 defining the preferred base layer for the release liner, with a visible rectilinear grid 36 shown with broken lines. The grid can be applied by flexographic ink printing on either the front or back of the film, which is transparent or translucent. The grid pitch is preferably ½ inch or less. This facilitates the final alignment and cutting steps for completing the mounting of a graphic on a substrate such as foam board. Although a similar alignment and cutting procedure is practiced for heat-activated adhesive mounting, the procedure has been nearly impossible to implement with pressure-sensitive adhesive mounting, due to inadvertent premature sticking. With applicant's higher-projecting dots, inadvertent sticking is much less likely so the procedure is now routinely viable for pressure sensitive mounting.

The ability to align a rectilinear item (e.g., poster, photograph, map, or other graphic) on a rectilinear mounting board so it is square with the mounting board is critical to the success of the mounting. This is especially critical when the mounted graphic item is to be trimmed on a conventional substrate trimmer. Board cutters only trim at a 90 degree angle to a guide rail against which a straight edge of the board is aligned. If the graphic item is not square on the mounting board the completed project will appear skewed.

In order to align the mounting item square one needs a rectilinear grid, but the lines cannot be on the mounting surface under the adhesive because the lines could show through thin, light-colored graphic items after such items have been bonded to the adhesive on the board. The ideal place for the grid is on the release liner (either the top surface or the opposite surface) as represented in FIG. 8, with the qualification of some degree of translucency or transparency to the release liner to allow the mounting item to be seen through the release liner so that it can be aligned to the printed square grid on the release liner.

The board is generally purchased with a PSA coating covered by the release liner. The board and associated release liner are generally larger than the item to be mounted. As a result, most of the liner can be peeled back, transferring the dots to the exposed area of adhesive on the board that is larger than the item, while some of the release liner remains attached to the board. The item can then be aligned and placed on the board between the printed grid of the release liner and the adhesive coated mounting board, while simultaneously seeing the grid lines and the edge of the item. The release liner was laminated to the board during manufacturing so that grid is square with the board. If the liner is removed completely before mounting the item, then the original manufacturing alignment of the printed grid release liner and the adhesive board will be lost.

Notwithstanding that the adhesive on the board is pressure sensitive, with the present invention the mounting item can be slid around on the adhesive with the hand to align it with the grid before final mounting pressure is applied. No PSA coated mounting board known to the inventors will allow one to square up the mounting items by sliding the item on the adhesive for alignment. PSA coated boards rely on guesswork for alignment. We believe that only the inventive system will allow an item to be slid on the adhesive for proper alignment to the board prior to activating the adhesive.

1. A pressure activated mounting system for a decoration, comprising:
a rigid substrate having a base surface on which a decoration is to be applied;
a relatively softer cushion layer adhered to the base surface of the substrate;
a pressure sensitive adhesive layer having a lower surface adhered to the cushion layer and an active upper surface for securely mounting the decoration; and
a multiplicity of discrete barrier structures distributed on the adhesive layer and projecting from the upper surface.

2. The mounting system of claim 1, wherein the cushion layer comprises foam with a thickness range of about 0.030-0.125 inch and a density range of 2-10 lb. per cubic foot.

3. The mounting system of claim 1, wherein the barrier structures project from the upper surface of the adhesive layer a distance in the range of about 0.0010-0.0050 inch.

4. The mounting system of claim 3, wherein the barrier structures have a length transverse to the upper surface, of at least 0.0015 inch.

5. The mounting surface of claim 1, wherein the substrate is selected from the group consisting of metal, plastic, foam board and cellulosic.

6. The mounting system of claim 5, wherein the decoration is a sheet of graphics slidingly supported by the barrier structures above the adhesive layer.

7. The mounting system of claim 1, wherein the substrate is a building surface.

8. The mounting system of claim 7, wherein the decoration is a tile slidingly supported by the barrier structures above the adhesive layer.

9. The mounting system of claim 2, wherein
the barrier structures are discrete hard dots distributed uniformly on the adhesive layer, while projecting from the upper surface of the adhesive layer a distance of at least 0.0015 inch; and
the adhesive layer has a thickness of at least 0.0030 inch.

10. A pressure activated mounting system for a decoration, comprising:
a rigid substrate having a mounting surface;
a relatively softer nonadhesive cushion layer adhered to the mounting surface of the substrate;
a pressure sensitive adhesive layer having a lower surface adhered to the cushion layer and an active upper surface;
a multiplicity of discrete barrier structures embedded in the adhesive layer a distance of at least about 0.0015 inch, substantially flush with the active upper surface; and
a decoration permanently adhered to the active surface of the adhesive layer.

11. The mounting system of claim 10, wherein the barrier structures locally deform the adhesive layer and the cushion layer.

12. The mounting system of claim 10, wherein the substrate is selected from the group consisting of metal, plastic, foam board and cellulosic.

13. The mounting system of claim 10, wherein the substrate is a building surface.

14. The mounting system of claim 11, wherein the substrate is selected from the group consisting of metal, plastic, foam board and cellulosic.

15. A pressure activated adhesive mounting board comprising:
a board;
a cellular foam cushion layer with a thickness range of about 0.030-0.125 inch and a density range of about 2-10 lb. per cubic foot adhered directly onto the board;
a pressure sensitive adhesive layer adhered directly onto the cushion layer, having a nominal thickness of at least 0.0030 inch and a nominally flat active surface; and
a multiplicity of discrete hard barrier structures distributed on about 5%-30% of the active surface, each projecting from the active surface at least 0.0010 inch.

16. The mounting board of claim 15, wherein the barrier structures project at least about 0.0015 inch.

17. A graphics mounting adhesive system comprising:
a primary pressure sensitive adhesive layer having an upper surface for receiving the graphic and a lower surface;
a multiplicity of discrete barrier structures in contact with and projecting from the upper surface of the adhesive layer; and
a nonadhesive cushion layer having an upper surface adhered to the lower surface of the primary adhesive layer.

18. The graphics mounting adhesive system of claim 17, including another, secondary pressure sensitive adhesive layer, adhered to the lower surface of the cushion layer.

19. The graphics mounting adhesive system of claim 18, including a release liner on the lower surface of the secondary adhesive layer.

20. A transfer liner comprising:
a non-adhesive base film having opposite first and second surfaces;
a non-adhesive carrier layer, having a first surface bonded to the first surface of the base film and an opposite second surface covered with a release material;
a multiplicity of discrete hard dot structures uniformly distributed within the carrier layer; and
wherein the dots have a length of at least 0.0015 inch, transverse to the second surface of the carrier layer, and are embedded in the carrier layer flush with release material.

21. The transfer liner of claim 20, wherein a pressure sensitive adhesive layer having a thickness of at least 0.0030 inch confronts the release material.

22. The transfer liner of claim 20, wherein
the base film has a melt temperature above 250 F; and
the carrier layer has a melt temperature below 250 F.

23. The transfer liner of claim 20, wherein a grid pattern of the transfer liner is visible through the transfer liner.

25. The transfer liner of claim 20, wherein the adhesive layer has a thickness of at least 0.0030 inch.

26. The transfer liner of claim 20, wherein
the base layer is a transparent paper, PET, or high-density polyethylene having a top side to bottom side thickness in the range of about 0.004-0.008 inch, with a visible printed rectilinear pattern;
the carrier layer is an extruded EVA polymer, having a thickness of at least about 0.0030 inch; and
the dots are substantially uniformly distributed in about 5-25% of the carrier layer and release material.

27. The transfer liner of claim 20 in combination with a mounting substrate, comprising:
a cushion layer adhered to the mounting substrate; and
a pressure sensitive adhesive layer adhered to the cushion layer;
wherein the release material of the carrier layer confronts the adhesive layer with the multiplicity of dots remaining flush with the release material.

28. The transfer liner of claim 20, further comprising:
a cushion layer;
a primary pressure sensitive adhesive layer having a first side adhered to a first side of the cushion layer;
a secondary pressure sensitive adhesive having a first side bonded to a second, opposite side of the cushion layer; and
a release sheet covering a second, opposite side of the secondary adhesive layer;
wherein the release material of the carrier layer confronts a second, opposite side of the primary adhesive layer with the multiplicity of dots remaining flush with the release material.

29. The transfer liner of claim 21, including a release coating on the second surface of the base film and wherein the transfer liner is in the form of a continuous roll with the adhesive layer confronting the release coating of the base film.

30. The transfer liner of claim 27, wherein a grid pattern of the transfer liner is visible through the transfer liner.
